(19) United States
(12) Patent Application Publication
(10) Pub. No.: US 2002/0194723 A1
(43) Pub. Date: Dec. 26, 2002

(54) Method for producing a tape

(76) Inventors: Jinxing Shen, Heidelberg (DE); Roland Oesterlein, Heidelberg (DE); Tom Porteous, Oxford (GB); Flemming Vedsted, Bjerring (DK); Mogens F. Jacobsen, Fredericia (DK); Ilkka Ikonen, Vaasa (FI)

Correspondence Address: LERNER AND GREENBERG, P.A., Post Office Box 2480, Hollywood, FL, 33022-2480, US

(21) Appl. No.: 10/128,116

(22) Filed: Apr. 23, 2002

Related U.S. Application Data
(63) Continuation of application No. PCT/EP00/10184, filed on Oct. 17, 2000.

(30) Foreign Application Priority Data
Oct. 23, 1999 (DE) 199 51 180.2

(51) Int. Cl. H02K 15/00; H02K 15/14

(52) U.S. Cl. 29/596; 29/412; 29/432

(57) ABSTRACT

A method for producing finished tapes for winding an annular magnetic core is described. The method includes providing an endless flat strip formed from a metal that conducts a magnetic flux. At least two tapes of equal size are cut out of the endless flat strip. Each of the two tapes is subdivided into sections of equal size having concave bulges and convex bulges. The two tapes have equilateral open triangles cut out of them that have opening angles and heights at predetermined points. A distance between each two successive equilateral open triangles has a length defined by:

L=Dᵢ*sin(π/(nₛ±1/m)),

where Dᵢ is an internal diameter of the annular magnetic core, nₛ±1/m is a number of the sections between the equilateral open triangles which are required to wind one layer of a tape, and m is a length of an overlap of the sections from layer to layer.

### CROSS-REFERENCE TO RELATED APPLICATION

This application is a continuation of copending International Application No. PCT/EP00/10184, filed Oct. 17, 2000, which designated the United States.

### BACKGROUND OF THE INVENTION

### FIELD OF THE INVENTION

The invention relates to a method for producing a tape for winding an annular magnetic core.

Such annular magnetic cores are used, for example, for producing stators for rotating electrical machines, which have an internal rotor and an external stator. The stator is assembled from an outer stator ring and an inner stator ring.

A stator for a dynamoelectric machine, which is produced by winding tapes onto it, is known from Published, European Patent Application EP 0 871 282 A. As can be seen only from FIGS. 1 and 22 in this document, the tapes are manufactured from an endless flat strip, whose thickness is matched to the desired thickness of the tapes. The width of the strip is in this case chosen such that two tapes of equal size can be cut out of it. Equilateral triangles, which are open along the first longitudinal edge of each tape and are provided with defined opening angles and heights, are cut out of each tape at predetermined points. The axis of symmetry of each triangle is aligned at right angles to the longitudinal axis of the respective tape. A hole with a predetermined cross section is formed at the internal tip of each triangle. The tapes are subdivided into sections of equal size, which have concave bulges along the first longitudinal edges and convex bulges along the second longitudinal edges. The tapes are provided with additional webs over which electrical coils are pushed, and are attached to these webs.

The production of a rotating electrical machine is described in Published, French Patent Application FR 2 109 301 A. As can now be seen from FIGS. 1 to 5, the stator and the rotor of the machine are each produced from a tape, which is wound onto a drum for this purpose. The tape is cut from a strip whose thickness is matched to the thickness of the tape. The width of the strip is chosen such that two tapes can be cut out of it at the same time, and can each be wound to form a stator or rotor. Recesses are cut out of the tapes, and form cavities after completion of the stator. The cavities are aligned parallel to the longitudinal axis of the stator.

A dynamoelectric machine whose core is wound from a tape is known from U.S. Pat. No. 4,365,180. As FIGS. 1 to 3 show, the tape is provided with teeth that point outward. Two immediately adjacent teeth are in each case separated from one another by an annular recess. The strip is subdivided into sections, which are convex along the first longitudinal edge and are concave along the second longitudinal edge. The recesses form cavities during the winding process. These cavities are aligned parallel to the longitudinal axis of the core.

German Patent Application 19 34 858.8 describes a rotating electrical machine, in which the outer stator ring and the inner stator ring are held together by a shrunk joint. Each of the two rings is wound from a specifically shaped tape.

### SUMMARY OF THE INVENTION

It is accordingly an object of the invention to provide a method for producing a tape which overcomes the above-mentioned disadvantages of the prior art methods of this general type, in which it is possible easily and cost-effectively to produce a tape which is suitable for winding an annular magnetic core.

With the foregoing and other objects in view there is provided, in accordance with the invention, a method for producing finished tapes for winding an annular magnetic core. The method includes providing an endless flat strip having a thickness matched to a desired thickness of the finished tapes. The endless flat strip is formed from a metal that conducts a magnetic flux. At least two tapes of equal size are cut out of the endless flat strip. Each of the two tapes is subdivided into sections of equal size having concave bulges formed along a first longitudinal edge of each of the two tapes and convex bulges formed along a second longitudinal edge of each of the two tapes. The two tapes have equilateral open triangles cut out of them that have defined opening angles and heights at predetermined points along the first longitudinal edge. The equilateral open triangles have a symmetry aligned at right angles to a longitudinal axe of each of the tapes. A distance between each two successive equilateral open triangles has a length defined by:

L=Dᵢ*sin(π/(nₛ±1/m)),

where Dᵢ is an internal diameter of the annular magnetic core, nₛ±1/m is a number of the sections between the equilateral open triangles which are required to wind one layer of a tape, and m is a length of an overlap of the sections from layer to layer. A hole with a predetermined cross section is formed at internal tips of each of the equilateral open triangles.

In accordance with an added mode of the invention, there are the steps of setting a size of the defined opening angles of the equilateral open triangles in dependence on the number of the sections, and matching a width of the strip to a width of at least the two tapes.

In accordance with another mode of the invention, there are the steps of setting a size of the defined opening angles of the equilateral open triangles in dependence on a number of the sections, setting a width of the strip to be narrower than an overall width of the two tapes in order to save material, and flattening the concave bulges of the sections in edge regions and/or the convex bulges of the sections in central regions to match the two tapes to the width of the strip.

In accordance with a further feature of the invention, there is the step of using a laser of a stamping apparatus to cut the two tapes out of the strip and to form the first and second longitudinal edges of the two tapes, and in that, when a pattern which is to be cut out of the strip for the two tapes is applied, the sections of a first tape are disposed offset with respect to the sections of a second tape.

Other features which are considered as characteristic for the invention are set forth in the appended claims.

Although the invention is illustrated and described herein as embodied in a method for producing a tape, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, illustration of a strip of metal with parallel longitudinal edges useful for describing a method according to the invention;

FIG. 2 is an illustration of a partially processed strip;

FIG. 3 is an illustration showing triangles being stamped out of one of the tapes shown in FIG. 4;

FIG. 4 is an illustration of two tapes, which are produced from the strip shown in FIG. 2;

FIG. 5 is an illustration showing a method for producing two tapes at the same time;

FIG. 6 is an illustration showing the production of two tapes, with material being saved;

FIG. 7 is an illustration showing a further method for saving material;

FIG. 8 is an illustration showing a production of four tapes at the same time;

FIG. 9 is an illustration showing a winding of an annular magnetic core from a tape; and

FIG. 10 is a diagrammatic, perspective view of a wound annular magnetic core.

### DESCRIPTION OF THE PREFERRED EMBODIMENTS

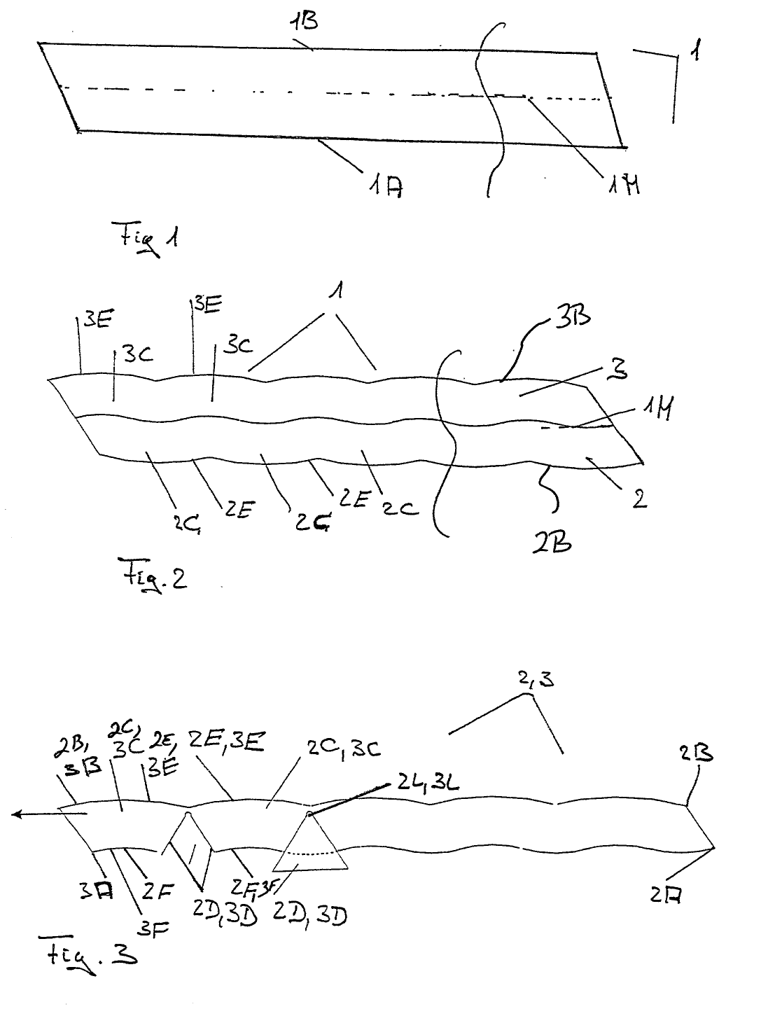

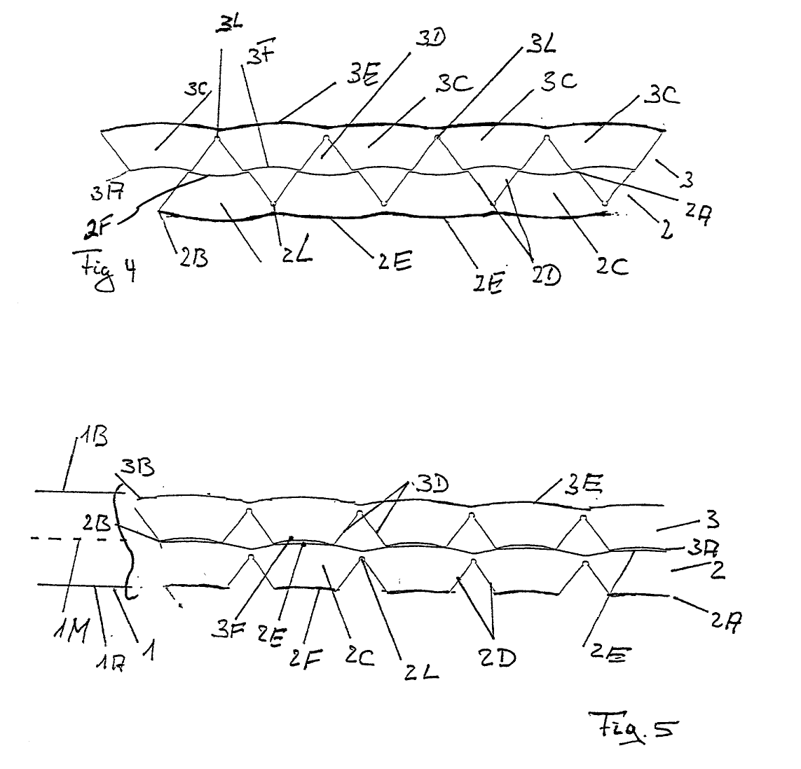

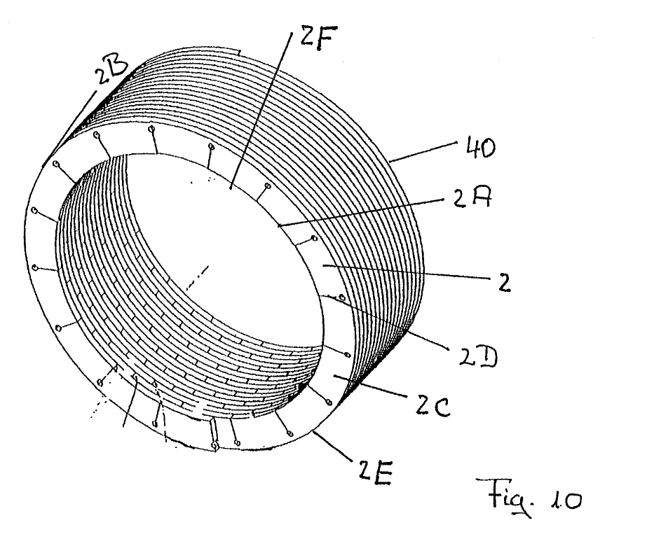

Referring now to the figures of the drawing in detail and first, particularly, to FIG. 1 thereof, there is shown a flat strip 1, which has two longitudinal edges 1A and 1B running parallel to one another. The strip 1 is manufactured from a metallic material that conducts magnetic flux well. The dimensions of the strip 1 are chosen such that two tapes 2, 3 can be produced from it. One of the tapes is shown in FIG. 9, illustrating how it is wound onto a mandrel 60. Each of the tapes 2, 3 has a length such that an annular magnetic core 40, also referred to as a core for short in the following text, can be wound completely from it, as is illustrated in FIG. 10. In order to produce the tapes 2, 3, the parallel longitudinal edges 1A and 1B of the strip 1 are initially processed using the beams of a laser such that sections 2C, 3C are formed, which have convex bulges 2E, 3E, as is illustrated in FIG. 2. The sections 2C, 3C are all of the same size. The convex bulges 2E are disposed offset with respect to the convex bulges 3E. During the processing of the longitudinal edges 1A and 1B of the strip 1, which, after being cut out of the tapes 2 and 3, form the longitudinal edges 2B and 3B. The strip 1 is at the same time cut through along a center line 1M, so that two tapes 2, 3 of equal width are formed. A non-illustrated laser is likewise used to cut through the strip 1.

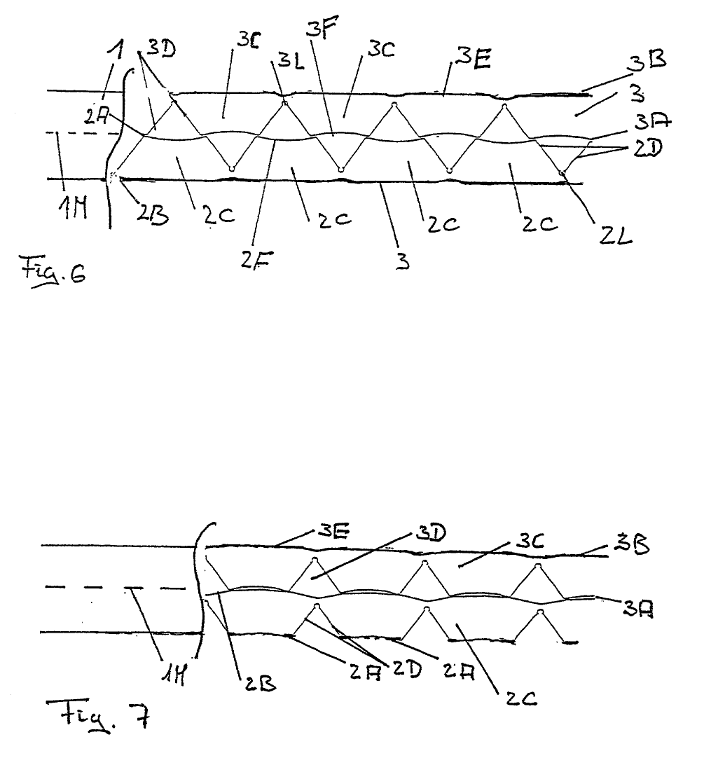

The strip 1 is subdivided such that the sections 2C, 3C are provided with concave bulges 2F, 3F along the longitudinal edges 2A, 3A of the tapes 2 and 3, as shown in FIG. 4. Instead of the laser, a non-illustrated stamping apparatus can also be used to cut the tapes 2 and 3 out of the strip 1 and to form the longitudinal edges 2A, 3A, 2B, 3B.

The longitudinal edges 2A, 3A are disposed at right angles on the mandrel 60 while the core 40 is being wound, as is illustrated in FIG. 9. As is shown in FIG. 3, equilateral triangles 2D, 3d with defined opening angles and heights are now stamped out of the tapes 2 and 3 and are open toward the first longitudinal edge 2A, 3A of the tape 2, 3. As is shown in FIG. 3, each of the tapes 2, 3 is moved from right to left while the triangles 2D, 3D are being stamped out. In FIG. 4, the two tapes 2 and 3 have already been completely separated from one another, and the triangles 2D and 3D have also already been formed. A laser is also preferably used for this purpose. They are shown closely alongside one another, once again, only to indicate how they are produced from the strip 1 shown in FIG. 1.

A size of an opening angle of the triangles 2D is governed by the number nₛ of sections 2C. The distance between two successive triangles 2D, 3D is defined by the equation L=Dᵢ*sin(π/(nₛ±1/m)). In this case, Dᵢ is an internal diameter of the core 40. nₛ±1/m is the number of sections 2C, 3C between the triangles 2D, 3D which are required in order to wind one layer of the tape 2, 3, while m is the length of the overlap of the triangles 2D, 3D, which are closed after the winding process, from layer to layer. The internal tips of the triangles 2D, 3D are all provided with a hole 2L, 3L of defined size, which is likewise stamped out. As FIG. 9 shows, a tool 50, for example, can be inserted into the holes 2L and is used to correctly position the tape 2 during the winding process.

As FIG. 5 shows, the strip 1 can also be processed using a laser such that the first longitudinal edge 1A has sections 2C which have concave bulges, while the second longitudinal edge 1B has sections 3C which have convex bulges. All the sections 2C and 3C are of the same size. The strip 1 is then cut through along the center line 1M. In the process, two tapes 2 and 3 of the same width are formed.

The strip 1 is cut through such that the sections 2C of the tape 2 are provided with a convex bulge 2E, while concave bulges 3F are formed in the sections 3C of the tape 3. In this case, the convex bulges 2E and the concave bulges 3F point toward the original center line 1M. Once the two tapes 2, 3 have been formed to this extent, the equilateral triangles 2D, 3D are stamped out from them. The triangles 2D, 3D are open toward the first longitudinal edges 2A and 3A of the tapes 2, 3. The axes of symmetry of the triangles 2D, 3D are aligned at right angles to the longitudinal axis of the tape 2, 3. The size of the opening angle is defined in the same way as for the tape 2, 3, as is illustrated in FIGS. 3 and 4 and explained in the associated descriptions.

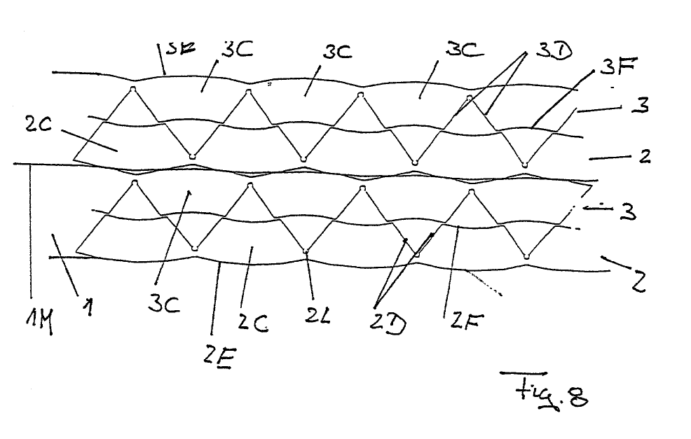

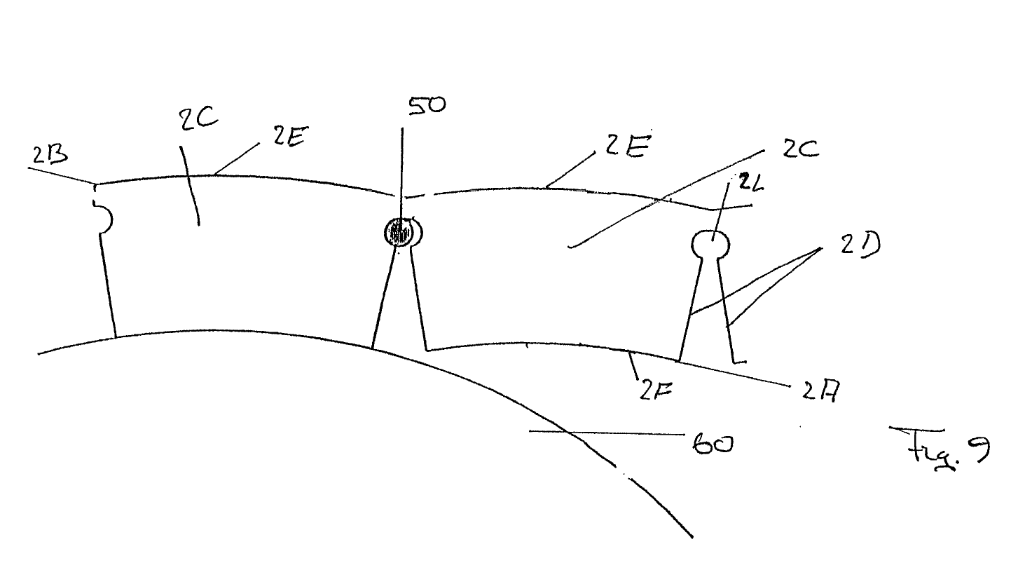

The tapes 2 and 3 illustrated in FIGS. 6 and 7 are produced according to the methods as explained in the descriptions relating to FIGS. 2, 3 and 5. When producing the tapes 2 and 3 as shown in FIGS. 6 and 7, the aim is to save material. The tapes 2 and 3 are therefore produced from the strip 1 whose width is narrower than the overall width of the tapes 2 and 3, which are shown in FIGS. 2, 3 and 5. As can be seen from FIG. 6, the saving of material results in that the sections 2C and 3C toward the outside do not have complete convex bulges, but are flattened in the central region. In the case of the tapes 2 and 3 as illustrated in FIG. 7 and produced using the method shown in FIG. 5, the concave bulges 2F of the sections 2C are flattened in the edge regions, while the convex bulges 3E of sections 3C are flattened in the central region.

FIG. 8 shows the strip 1 whose width is sufficiently large that it corresponds to the width of in each case two strips 2 and 3, that is to say to a total of four strips. The two tapes 2 and 3 are formed according to the method on each of the two sides of the center line 1M of the strip 1, as illustrated in FIGS. 2 and 3 and as explained in the associated description. However, the tapes 2, 3 can also be produced using the method as illustrated in FIG. 5 and as explained in the associated description. Material can also be saved when producing the tapes 2 and 3 using this method. Only one strip 1 need be used, whose width is less than the width of each two tapes 2 and 3.

We claim:

1. A method for producing finished tapes for winding an annular magnetic core, which comprises the steps of:
providing an endless flat strip having a thickness matched to a desired thickness of the finished tapes, the endless flat strip formed from a metal which conducts a magnetic flux;
cutting at least two tapes of equal size out of the endless flat strip;
subdividing each of the two tapes into sections of equal size having concave bulges formed along a first longitudinal edge of each of the two tapes and convex bulges formed along a second longitudinal edge of each of the two tapes;
cutting out of the two tapes equilateral open triangles with defined opening angles and heights at predetermined points along the first longitudinal edge, the equilateral open triangles having a symmetry aligned at right angles to a longitudinal axe of each of the tapes, a distance between each two successive equilateral open triangles has a length defined by:
L=Dᵢ*sin(π/(nₛ±1/m)),
where Dᵢ is an internal diameter of the annular magnetic core, nₛ±1/m is a number of the sections between the equilateral open triangles which are required to wind one layer of a tape, and m is a length of an overlap of the sections from layer to layer; and
forming a hole with a predetermined cross section at internal tips of each of the equilateral open triangles.

2. The method according to claim 1, which comprises:
setting a size of the defined opening angles of the equilateral open triangles in dependence on the number of the sections; and
matching a width of the strip to a width of at least the two tapes.

3. The method according to claim 1, which comprises:
setting a size of the defined opening angles of the equilateral open triangles in dependence on a number of the sections;
setting a width of the strip to be narrower than an overall width of the two tapes in order to save material; and
flattening at least one of the concave bulges of the sections in edge regions and the convex bulges of the sections in central regions to match the two tapes to the width of the strip.

4. The method according to claim 1, which comprises using a laser of a stamping apparatus to cut the two tapes out of the strip and to form the first and second longitudinal edges of the two tapes, and in that, when a pattern which is to be cut out of the strip for the two tapes is applied, the sections of a first tape are disposed offset with respect to the sections of a second tape.
